(19) United States
(12) Patent Application Publication
(10) Pub. No.: US 2021/0172779 A1
(43) Pub. Date: Jun. 10, 2021

(54) SYSTEMS AND METHODS FOR CONTROL OF AN AIR DUCT

(71) Applicant: Johnson Controls, Inc., Milwaukee, WI (US)

(72) Inventor: Jean H. Scholten, Roswell, GA (US)

(73) Assignee: Johnson Controls, Inc., Milwaukee, WI (US)

(21) Appl. No.: 17/180,354

(22) Filed: Feb. 19, 2021

Related U.S. Application Data
(63) Continuation-in-part of application No. 16/993,812, filed on Aug. 14, 2020.
Application No. 16/993,812 is a continuation of application No. 16/251,011, filed on Jan. 17, 2019, now Pat. No. 10,768,031.
(60) Provisional application No. 62/618,142, filed on Jan. 17, 2018.

(51) Int. Cl. G01F 1/684; G05D 7/00; G01F 5/00; F24F 11/30; F24F 11/49; F24F 11/74; F24F 13/10; G01F 1/40; F24F 110/40

(52) U.S. Cl. CPC G01F 1/684; G05D 7/00; G01F 5/00; F24F 11/30; F24F 2110/40; F24F 11/74; F24F 13/10; G01F 1/40; F24F 11/49

(57) ABSTRACT

A controller for an HVAC system includes processing circuitry configured to perform a volumetric offset control (VOC) scheme based on a flowrate offset setpoint to operate a valve to drive an actual flowrate offset between a supply rate of air entering a space and an exhaust rate of air leaving the space toward the flowrate offset setpoint. In some embodiments, the valve is configured to control the supply rate of air entering the space or the exhaust rate of air leaving the space and to provide sensor data indicating a flowrate therethrough. In some embodiments, the processing circuitry is configured to monitor a pressure of the space to detect a pressure condition and update the flowrate offset setpoint in response to detecting the pressure condition. In some embodiments, the processing circuitry is configured to perform the VOC scheme based on the updated offset flowrate setpoint.

### CROSS-REFERENCE TO RELATED PATENT APPLICATIONS

This application is a continuation in part of U.S. application Ser. No. 16/993,812, filed Aug. 14, 2020, which is a continuation of U.S. application Ser. No. 16/251,011, filed Jan. 17, 2019, which claims benefit of and priority to U.S. Provisional Application No. 62/618,142, filed Jan. 17, 2018, the entire disclosures of which are incorporated by reference herein.

### BACKGROUND

The present disclosure relates, in exemplary embodiments, to air duct airflow sensors. Air dampers are mechanical valves used to permit, block, and control the flow of air in air ducts. Typically, a pressure sensor is incorporated to detect and measure the air pressure in the air duct. Pressure measurement can be used to determine the desire amount of airflow and to actuate a damper to open or close, thus affecting airflow.

It would be desirable to have an airflow sensor that would not be dependent on airflow orientation so as to permit location of sensor closer to a bend in the air duct than conventional sensors can be positioned. It would be desirable to have an airflow sensor less susceptible to clogging.

### SUMMARY

One implementation of the present disclosure is a heating, ventilation, or air conditioning (HVAC) system for a space. In some embodiments, the HVAC system includes a valve configured to control an exhaust flowrate of exhaust air that exits the space or a supply flowrate of inlet air that enters the space. In some embodiments, the valve is configured to provide sensor data indicating a flowrate therethrough. In some embodiments, the pressure differential sensor is configured to measure an actual pressure differential of the space relative to a reference pressure. In some embodiments, the controller is configured to determine an actual offset flowrate between the supply flowrate and the exhaust flowrate. In some embodiments, the controller is configured to operate the valve to adjust the exhaust flowrate or the supply flowrate to drive the actual offset flowrate toward an offset flowrate setpoint. In some embodiments, the controller is configured to obtain the actual pressure differential from the pressure differential sensor. In some embodiments, the controller is configured to update the offset flowrate setpoint in response to the actual pressure differential being greater than a maximum allowable pressure differential or less than a minimum allowable pressure differential.

In some embodiments, the valve is a first valve configured to measure an inlet pressure differential between two stream locations along the first valve and control the supply flowrate of air that enters the space, the inlet pressure differential indicating the supply flowrate through the first valve. In some embodiments, the HVAC system further includes a second valve configured to measure an outlet pressure differential between two stream locations along the second valve and control the exhaust flowrate of air that exits the space, the outlet pressure differential indicating the exhaust flowrate through the second valve.

In some embodiments, the controller is configured to obtain a value of the supply flowrate, a value of the exhaust flowrate, and a value of the actual pressure differential of the space. In some embodiments, the controller is configured to obtain the offset flowrate setpoint and a pressure deadband. In some embodiments, the controller is configured to operate the valve control the supply flowrate of inlet air that enters the space or the exhaust flowrate of exhaust air that exits the space based on the value of the supply flowrate, the value of the exhaust flowrate, the value of the actual pressure differential of the space, the offset flowrate setpoint, and the pressure deadband.

In some embodiments, updating the offset flowrate setpoint includes decreasing the offset flowrate setpoint by a decrease amount in response to the actual pressure differential being greater than the maximum allowable pressure differential. In some embodiments, updating the offset flowrate setpoint includes increasing the offset flowrate setpoint by an increase amount in response to the actual pressure differential being less than the minimum allowable pressure differential.

In some embodiments, the controller is configured to operate the valve to adjust the exhaust flowrate of the exhaust air or the supply flowrate of inlet air to drive the actual offset flowrate towards the updated offset flowrate setpoint.

In some embodiments, the controller is configured to detect a pressure override condition based on the actual pressure differential of the space, and detect whether a door of the space is open. In response to detecting that the door of the space is not open, the controller may update the offset flowrate setpoint in response to the pressure override condition, according to some embodiments. In response to detecting that the door of the space is open, the controller may delay update of the offset flowrate setpoint until the door of the space is not open.

In some embodiments, the controller is configured to operate the valve to adjust the exhausr flowrate of the exhaust air or the supply flowrate of the inlet air to drive an actual offset flowrate towards the updated offset flowrate setpoint.

In some embodiments, the valve includes a sidewall defining an inner surface, and an air damper assembly. In some embodiments, the air damper assembly includes multiple fingers positioned along a circumference of a structural member of the air damper assembly and having different lengths along the circumference of the structural member. In some embodiments, the first valve and the second valve each include an actuator configured to drive the air damper assembly to rotate. In some embodiments, the multiple fingers are configured to contact the inner surface of the sidewall to adjust a cross-sectional flow area and thereby adjust flowrate of air through the valve.

Another implementation of the present disclosure is a controller for an HVAC system, according to some embodiments. In some embodiments, the controller includes processing circuitry configured to perform a volumetric offset control (VOC) scheme based on a flowrate offset setpoint to operate a valve to drive an actual flowrate offset between a supply rate of air entering a space and an exhaust rate of air leaving the space toward the flowrate offset setpoint. In some embodiments, the valve is configured to control the supply rate of air entering the space or the exhaust rate of air leaving the space and to provide sensor data indicating a flowrate therethrough. In some embodiments, the processing circuitry is configured to monitor a pressure of the space to detect a pressure condition and update the flowrate offset setpoint in response to detecting the pressure condition. In some embodiments, the processing circuitry is configured to perform the VOC scheme based on the updated offset flowrate setpoint.

In some embodiments, the valve is an exhaust valve configured to control the exhaust rate of air leaving the space. In some embodiments, performing the VOC scheme includes operating the exhaust valve of the space to adjust the exhaust rate of air leaving the space to drive the actual flowrate offset toward the flowrate offset setpoint. In some embodiments, performing the VOC scheme also includes operating a supply valve of the space to adjust the supply rate of air entering the space to achieve a desired environmental condition of the space.

In some embodiments, monitoring the pressure of the space to detect the pressure condition includes obtaining the pressure of the space, comparing the pressure of the space to a high pressure limit and a low pressure limit, and detecting the pressure condition in response to the pressure of the space being greater than the high pressure limit or less than the low pressure limit.

In some embodiments, updating the flowrate offset setpoint includes increasing the flowrate offset setpoint by a predetermined increase amount in response to the pressure of the space being greater than the high pressure limit, and decreasing the flowrate offset setpoint by a predetermined decrease amount in response to the pressure of the space being less than the low pressure limit.

In some embodiments, the processing circuitry is configured to limit subsequent increases of the flowrate offset setpoint in response to the flowrate offset setpoint being equal to a maximum limit, and limit subsequent decreases of the flowrate offset setpoint in response to the flowrate offset setpoint being equal to a minimum limit.

In some embodiments, the processing circuitry is further configured to obtain a status from a door sensor, the status indicating whether a door of the space is opened or closed. In some embodiments, the processing circuitry is configured to prevent updates to the flowrate offset setpoint until the door of the space is closed in response to the status indicating that the door of the space is opened. In some embodiments, the processing circuitry is configured to prevent updates to the flowrate offset setpoint until a delay time period has passed in response to the status of the door transitioning from opened to closed.

Another implementation of the present disclosure is a method for controlling an HVAC system of a space, according to some embodiments. In some embodiments, the method includes operating a valve of the space according to a volumetric offset control (VOC) scheme to drive an actual offset flowrate between the supply valve and the exhaust valve to drive an actual offset flowrate between a supply rate of air entering the space and an exhaust rate of air leaving the space toward a VOC setpoint. In some embodiments, the valve is configured to control the supply rate of air entering the space or the exhaust rate of air leaving the space and to provide sensor data indicating a flowrate therethrough. In some embodiments, the method includes detecting a pressure condition of the space, and in response to detecting the pressure condition of the space, updating the VOC setpoint to determine an adjusted VOC setpoint, and operating the valve of the space according to the VOC scheme based on the adjusted VOC setpoint.

In some embodiments, the pressure condition includes at least one of a pressure of the space exceeding a high pressure limit, or the pressure of the space being less than a low pressure limit.

In some embodiments, updating the VOC setpoint includes increasing the VOC setpoint by an increase amount in response to the pressure of the space being less than the low pressure limit or decreasing the VOC setpoint by a decrease amount in response to the pressure of the space being greater than the high pressure limit.

In some embodiments, the VOC setpoint is a setpoint offset amount between the supply rate of air entering the space and the exhaust rate of air leaving the space.

In some embodiments, the method includes limiting updates to the VOC setpoint in response to a door of the space being opened until the door is closed for a predetermined amount of time, and delaying updates to the VOC setpoint for the predetermined amount of time in response to the door of the space transitioning from opened to closed.

In some embodiments, the valve includes a sidewall defining an inner surface, an air damper assembly, and an actuator. In some embodiments, the air damper assembly includes multiple fingers positioned along a circumference of a structural member of the air damper assembly and having different lengths along the circumference of the structural member. In some embodiments, the actuator is configured to drive the air damper assembly to rotate. In some embodiments, the multiple fingers are configured to contact the inner surface of the sidewall to adjust a cross-sectional flow area and thereby adjust a flowrate of air through the valve.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The drawings disclose exemplary embodiments in which like reference characters designate the same or similar parts throughout the figures of which:

FIG. 1 is an isometric view of an air duct assembly, according to some embodiments.

FIG. 2 is a side cross-sectional view of an air duct airflow sensor assembly, according to some embodiments.

FIG. 3 is a side cutaway view of the air duct assembly of FIG. 1, according to some embodiments.

FIG. 4 is a top elevation view of the air duct assembly of FIG. 1, according to some embodiments.

FIG. 5 is an exploded perspective view of an air duct, ring and gasket components that can be utilized in the air duct assembly of FIG. 1, according to some embodiments.

FIG. 6 is another top view of the air duct assembly of FIG. 1, according to some embodiments.

FIG. 7 is a side cross-sectional view of the air duct assembly taken along the line B-B of FIG. 6, according to some embodiments.

FIG. 8 is a detail view C-C of the nipple, gasket and tube, according to some embodiments.

FIG. 9 is a detail view D-D of the gasket, according to some embodiments.

FIG. 10 is a side cross-sectional view of another air duct airflow sensor assembly, according to some embodiments.

FIG. 11 is a side cross-sectional view of another air duct airflow sensor assembly, according to some embodiments.

FIG. 12 is a diagram of a control system for a space that uses inlet and outlet valves, according to some embodiments.

FIG. 13 is a diagram of a controller of the control system of FIG. 12, according to some embodiments.

FIG. 14 is a flow diagram of a process for performing volumetric offset control (VOC), according to some embodiments.

FIG. 15 is a flow diagram of a process for performing pressure based control, according to some embodiments.

FIG. 16 is a flow diagram of a process for performing a hybrid VOC and pressure based control, according to some embodiments.

FIG. 17 is a block diagram of functionality of a hybrid VOC and pressure based control of the controller of FIG. 13, according to some embodiments.

FIG. 18 is a side view of a portion of the air duct assembly of FIGS. 1-11, according to some embodiments.

FIG. 19 is a diagram of a pressure differential sensor, according to some embodiments.

### DETAILED DESCRIPTION

Unless otherwise indicated, the drawings are intended to be read (for example, cross-hatching, arrangements of parts, proportion, degree, or the like) together with the specification, and are to be considered a portion of the entire written description of this invention. As used in the following description, the terms “horizontal”, “vertical”, “left”, “right”, “up” and “down”, “upper” and “lower” as well as adjectival and adverbial derivatives thereof (for example, horizontally”, “upwardly”, or the like), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

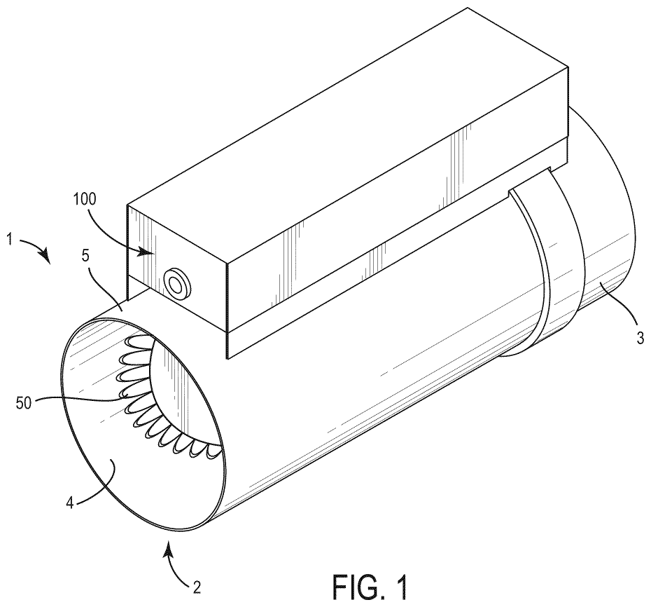

FIG. 1 depicts an isometric view of a cylindrical air duct assembly 1. As shown, the air duct assembly 1 includes a first end 2, a second end 3, and interior wall 4, an exterior wall 5, and a control assembly 100. Air duct assembly 1 is further shown to include an air damper assembly 50 situated within the interior wall 4 to control the volume of air flowing through the cylindrical air duct assembly 1. In some embodiments, the diameter of the interior wall 4 is approximately 10 inches or any other value.

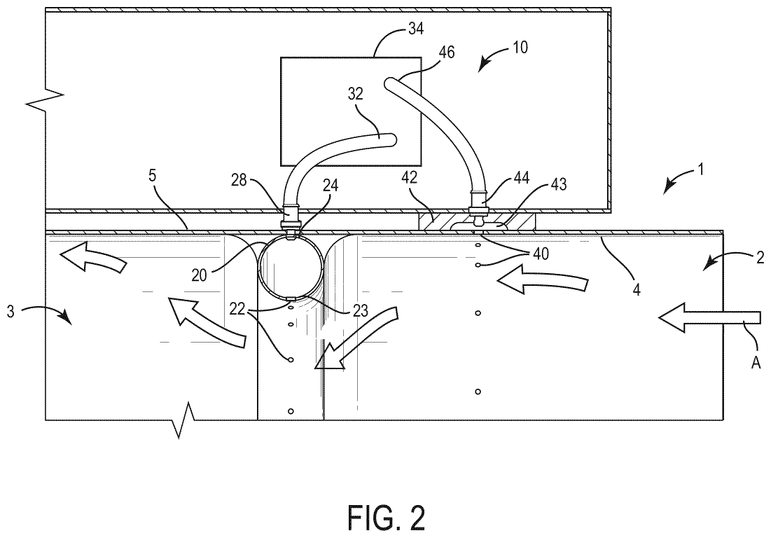

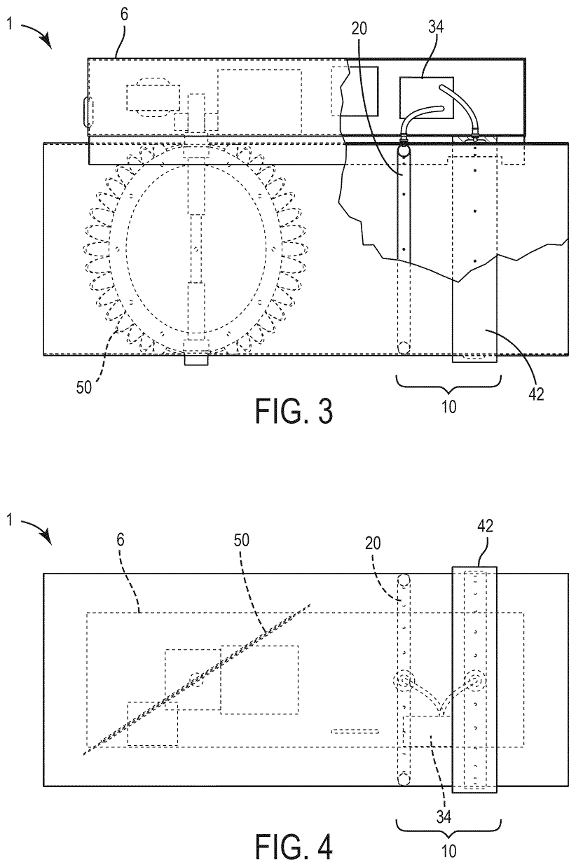

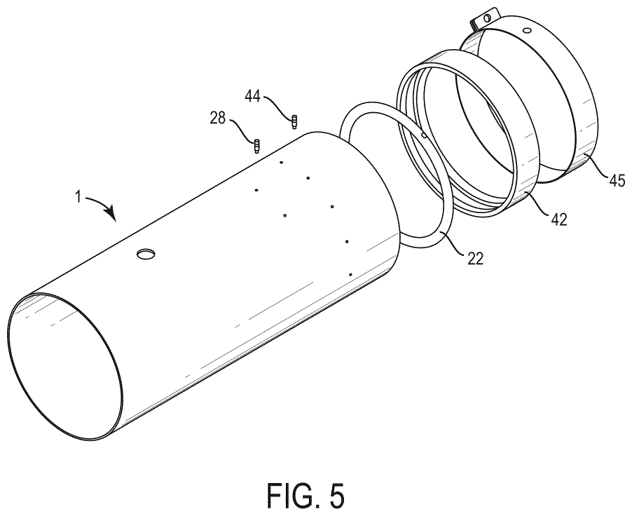

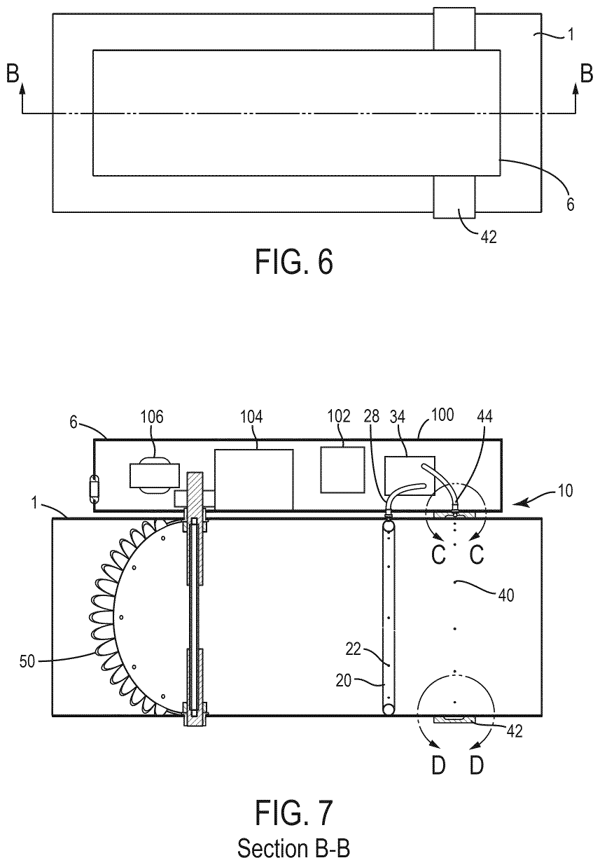

Referring now to FIGS. 2-9, various views depicting the air duct airflow sensor assembly 10 are shown, according to some embodiments. Air may flow through the air duct airflow sensor assembly 10 in the direction indicated by arrow “A” as shown in FIG. 2. The air duct airflow sensor assembly 10 includes a low pressure detection device and a high pressure detection device. The low pressure detection device comprises a hollow ring 20 which is mounted to or otherwise associated with the interior wall 4. In some embodiments, the outer diameter of the hollow ring 20 can range from 0.5 inches to 0.75 inches. In an exemplary embodiment, the outer diameter of the hollow ring 20 is 0.625 inches. The ring 20 has a plurality of apertures 22 defined in the inner periphery 23 of the ring (versus the outer periphery 24 which is proximate to the interior wall 4). In exemplary embodiments, the apertures 22 are disposed in the inner periphery of the ring 20 such that they are generally orthogonal to the orientation of airflow, so that air flows across the apertures 22, rather than flowing into the apertures 22.

A hollow connector nipple 28 is connected to an aperture defined in the ring 20 and an aperture defined in the duct 1. A tube 32 is connected to the nipple 28. Air flowing into the apertures 22 can flow through the ring 20, into the nipple 28, and through the tube 32. The tube 32 is connected to a pressure sensor 34 such that the air flowing through the tube 32 is received and detected by the flow pressure sensor 34. The ring 20 serves two purposes: as an air collection device, and as an airflow restriction obstacle, so as to create a measurable pressure differential.

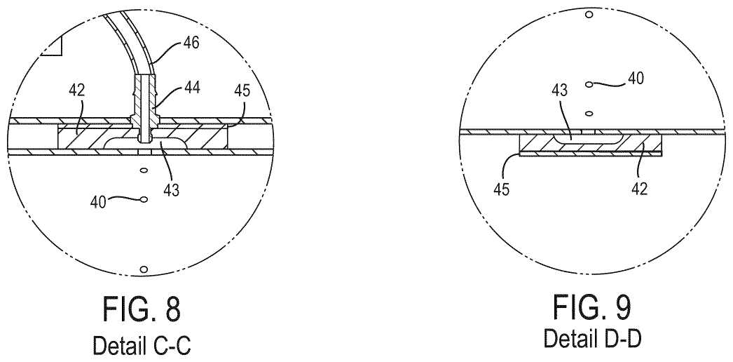

The air duct 1 further includes multiple apertures 40 defined therein, the apertures 40 being arranged generally in a ring-shape around the interior wall 4. A gasket 42 is associated with the exterior wall 5 and is located generally over the apertures 40. The gasket 42 has a recessed area 43 such that when associated with the exterior wall 5 a chamber 43 is formed. Detail views of the apertures 40 and chamber 43 are specifically depicted in FIGS. 8 and 9.

A hollow connector nipple 44 is connected to the gasket 42. In exemplary embodiments, a gasket guarding ring 45 may be used and is fitted over the gasket 42. A tube 46 is connected to the nipple 44. The tube 46 is connected to the pressure sensor 34. In an alternative exemplary embodiment, a separate pressure sensor (not shown) can be connected to the tube 46. The apertures 40, gasket 42, nipple 44, tube 46 and pressure sensor 34 form a high pressure sensor detection device.

In exemplary embodiments, the pressure sensor 34 is part of a control assembly 6 that controls the opening and closing of a damper 50. In one exemplary embodiment of a control assembly, specifically depicted in FIG. 7, a housing 100 is mounted to or otherwise associated with the air duct. A sensor 34, processor 102, actuator 104 and power supply 106 may be disposed within the housing 100. A damper 50 is in operational communication with the actuator 104.

In operation, air flowing through the duct 1 in the direction of arrow A first encounters the high pressure detection apertures 40. A portion of the air enters the apertures 40 and flows into the chamber 43. The air then moves into the tube 46 via the nipple 44, and then into the pressure sensor 34. The pressure detected is the “high” pressure in the duct 1, i.e., the pressure upstream from the airflow restrictor which is the ring 20.

Air flowing through the duct 1 next flows over the ring 20 and can enter the apertures 22 and travel through the nipple 28 and the tube 32, and into the pressure sensor 34. The pressure detected is the “low” pressure in the duct, i.e., the pressure at the point where airflow is restricted by the ring 20. The differential between the high pressure measurement and the low pressure measurement is an indication of the air velocity through the duct, specifically a scaled square root of the measured pressure (i.e., an application of Bernoulli's principle). The sensor 34 can send a signal to the control assembly 6 that in turn can cause the damper 50 to rotate so as to open or close the air duct 1.

In exemplary embodiments, the pressure sensor 34 is a “dead-end” pressure sensor (versus a flow-through sensor); i.e., after the initial pressure is established no further airflow goes through the sensor. This can reduce the chance of the apertures 22 and 40 becoming clogged.

In one exemplary embodiment, for an air duct having a 10 inch diameter, a 0.5 inch diameter ring 20 was used. With such a construction measurements of 850 CFM (cubic feet per minute) down to 35 CFM were obtainable with a 0.1 in Wg duct static. In other embodiments, a 0.625 inch diameter ring 20 may be utilized.

A benefit of the presently described sensor assembly is that because of the ring 20 design having the apertures 22 orthogonal to the airflow orientation, air to be diverted into the ring 20 flows over the apertures 22, rather than directly into the apertures 22. This can reduce the likelihood of the apertures 22 becoming clogged by dust, dirt and debris that accompanies the airstream.

Another benefit is that the presently disclosed apparatus is not dependent on airflow orientation. Typically, conventional pressure sensor apparatus, such as variable air volume (“VAV”) boxes, are dependent on airflow orientation, and having a bend or other transition in the duct in the general area where the sensor can result in inaccurate measurement due to the airflow disruption that naturally occurs proximate to the bend. With the air detection means of the presently disclosed apparatus, which is not airflow orientation dependent, the sensor assembly can be located closer to a bend or other transition in the air duct without affecting pressure measurement. This provides the duct system designer with greater flexibility in designing the placement of the valve assembly.

Another benefit of the presently described sensor assembly is that it presents minimal obstruction to the airflow and thus allows for greater CFM velocity at lower duct statics. Additionally, in the event any of the apertures 22 become blocked, it is easy to carry out periodic maintenance by disconnecting the sensor 34 and introducing a blast of compressed air into the tube 32 or tube 46. Any clogging debris will be blown out of the apertures 22 or 40, respectively.

Another benefit of the presently described sensor assembly as part of an overall sensor/controller/damper design is that it can operate off of a 0-10V control signal to provide the desired airflow. This allows a designer or operator to set a required CFM with a linear control signal from a control system.

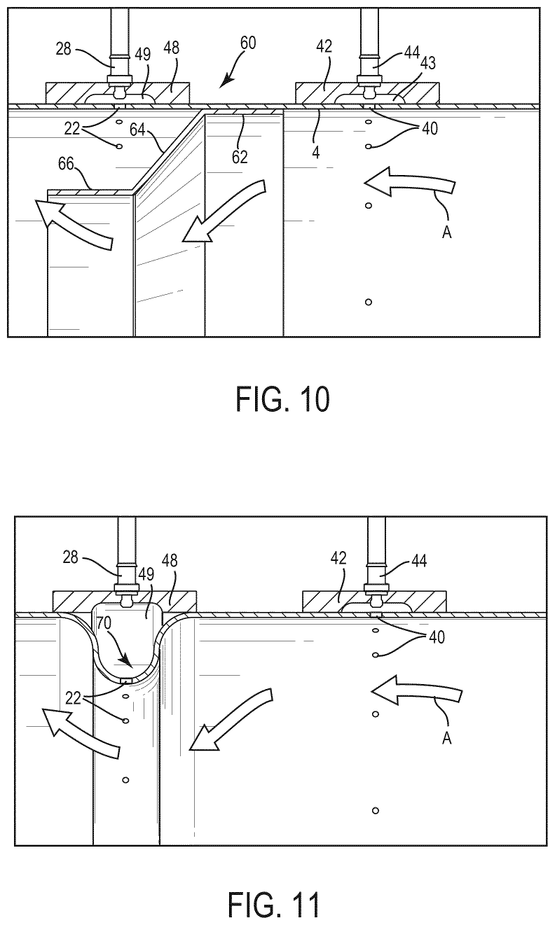

Referring now to FIGS. 10 and 11, alternate embodiments for airflow restriction used in the low pressure detection device are depicted. Specifically, FIG. 10 depicts an airflow sensor assembly including a shroud component 60. In some embodiments, the shroud component 60 can be ring-shaped, with an interior wall attachment portion 62, an inclined portion 64, and an aperture shielding portion 66, although any suitable shroud configuration or geometry may be utilized. In some embodiments, the aperture shielding portion 66 extends from the interior wall 4 a distance ranging from 0.5 inches to 0.75 inches.

The aperture shielding portion 66 is situated proximate apertures 22 disposed within the air duct 1. A gasket 48 is associated with the exterior wall 5 and is located generally over the apertures 22. In some embodiments, one or more gasket guarding rings (not shown) may be used and fitted over the gaskets 42, 48. The gasket 48 has a recessed area 49 such that when associated with the exterior wall 5 a chamber 49 is formed. Air flowing through the duct 1 flows over the interior wall attachment portion 62, the inclined portion 64, and the aperture shielding portion 66 of the shroud component 60 and can enter the apertures 22. The air can then travel through the chamber 49 into the nipple 28. Similar to the pressure measurement process described above with reference to FIGS. 1-9, after passing through the nipple 28, the air can travel through a tube and into a pressure sensor for the purpose of controlling an air damper assembly.

Turning now to FIG. 11, an airflow sensor assembly including a channel feature 70 is depicted. Similar to the shroud component 60 described above with reference to FIG. 10, the channel feature 70 may be utilized as an air restriction feature in place of the hollow ring 20 described above with reference to FIGS. 1-9. The channel feature 70 can include multiple apertures 22 distributed about a periphery of the channel feature 70. In some embodiments, the depth of the channel feature 70 can range from 0.5 inches to 0.75 inches. In an exemplary embodiment, the depth of the channel feature 70 is 0.625 inches. In other words, if the air duct 1 is nominally 10 inches in diameter, the diameter may reduce to 8.75 inches in the region of the channel feature 70.

A gasket 48 is associated with the exterior wall 5 and is located generally over the apertures 22. In some embodiments, one or more gasket guarding rings (not shown) may be used and fitted over the gaskets 42, 48. The gasket 48 has a recessed area 49 such that when associated with the exterior wall 5 a chamber 49 is formed. Air flowing through the duct 1 flows over the channel feature 70 and can enter the apertures 22. The air can then travel through the chamber 49 into the nipple 28. Similar to the pressure measurement process described above with reference to FIGS. 1-9, after passing through the nipple 28, the air can travel through a tube and into a pressure sensor for the purpose of controlling an air damper assembly.

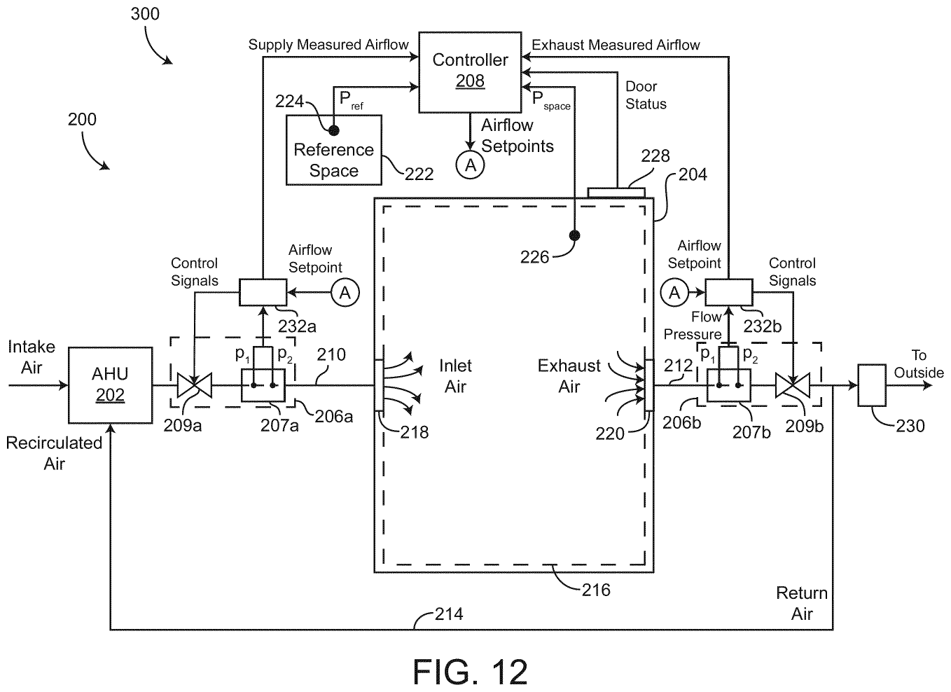

Referring now to FIG. 12, a heating, ventilation, and air conditioning (HVAC) system 200 for a space 216 is shown, according to some embodiments. The HVAC system 200 uses a first valve 206a for controlling inlet air that is provided to the space 216, a second valve 206b for controlling outlet air that exits the space 216, and an air handling unit (AHU) 202. The HVAC system 200 also includes a control system 300 including a controller 208 that is configured to generate and provide control signals or airflow setpoints to any of the first valve 206a, and/or the second valve 206b, or a first controller 232a and/or a second controller 232b of the first valve 206a and the second valve 206b. The first controller 232a and the second controller 232b can be components of the first valve 206a and the second valve 206b, respectively, and are configured to obtain airflow setpoints from the controller 208 and generate control signals for a control valve 209 portion of the first valve 206a and the second valve 206b. For example, the first controller 232a can be configured to obtain airflow setpoints for the first valve 206a and determine control signals for the control valve 209a (e.g., an actuator and damper of the first valve 206a thereof). Similarly, the second controller 232b can be configured to obtain airflow setpoints for the second valve 206b and determine control signals for the control valve 209b (e.g., an actuator and damper of the second valve 206b thereof). The first valve 206a and the second valve 206b can also include a pressure differential sensor 207a and a pressure differential sensor 207b, respectively, configured to measure a pressure differential of the air (e.g., the supply or intake air or the exhaust air) and provide the pressure differential to the first controller 232a or the second controller 232b, respectively. The first controller 232a and the second controller 232b are configured to use the pressure differential to determine a supply measured airflow and an exhaust measured airflow of air being provided to the space 216 and leaving the space 216 through the first valve 206a and the second valve 206b, respectively.

The first valve 206a and the second valve 206b can be the same as or similar to the air duct 1. In other embodiments, the first valve 206a and the second valve 206b are venturi valves. The air duct 1 can provide a higher range of duct pressure (e.g., a higher pressure drop across the air duct 1 while still being operational) than the venturi. In some embodiments, the venturi valve implemented as one or both of the first valve 206a and the second valve 206b is provided as a low pressure venturi valve or a medium pressure venturi valve. For example, the low pressure venturi valve can be configured to have a pressure drop thereacross of at least 0.3 inches water gauge, but less than 3 inches water gauge. In some embodiments, the medium pressure venturi valve can be configured to have a pressure drop thereacross of at least 0.6 inches water gauge, and at most 3 inches water gauge. In some embodiments, the air duct 1 is configured to have a 0.1 inch water gauge pressure drop thereacross (e.g., having a max cfm of 850 for a 10 inch valve). In some embodiments, the air duct 1 can still operate even if the pressure drop across the air duct 1 is less than 0.1 inch water gauge.

The space 216 can be an interior space of a room, building zone, etc., shown as zone 204. The zone 204 may be substantially sealed so that air that exits the space 216 exits through the second valve 206b. The HVAC system 200 includes an inlet vent 218 and an outlet vent 220. The AHU 202 can draw intake air (e.g., fresh air, outdoor air, etc.) and recirculated air. The AHU 202 can output air that is provided through a duct 210 and the first valve 206a. The duct 210 and the first valve 206a provide the air as inlet air to the space 216 through the inlet duct 218.

Air within the space 216 may exit through the outlet vent 220 (and an exhaust fan 230) which is fluidly coupled with a duct 212. The second valve 206b is fluidly coupled with the duct 212. Air that exits the space 216 or the second valve 206b (e.g., return air) can be recirculated to the AHU 202 through a duct 214, may egress to outside (e.g., outside a building), and/or may be filtered or otherwise processed.

The HVAC system 200 also includes the control system 300 including the controller 208. The controller 208 is configured to generate control signals for any of the first valve 206a, or the second valve 206b. The first valve 206a can operate to affect a flowrate of air that is provided to the space 216. The second valve 206b can operate to affect a flowrate of air that is removed from the space 216. The valves 206 may be the same as or similar to the cylindrical air duct assembly 1 as described in greater detail above with reference to FIGS. 1-11.

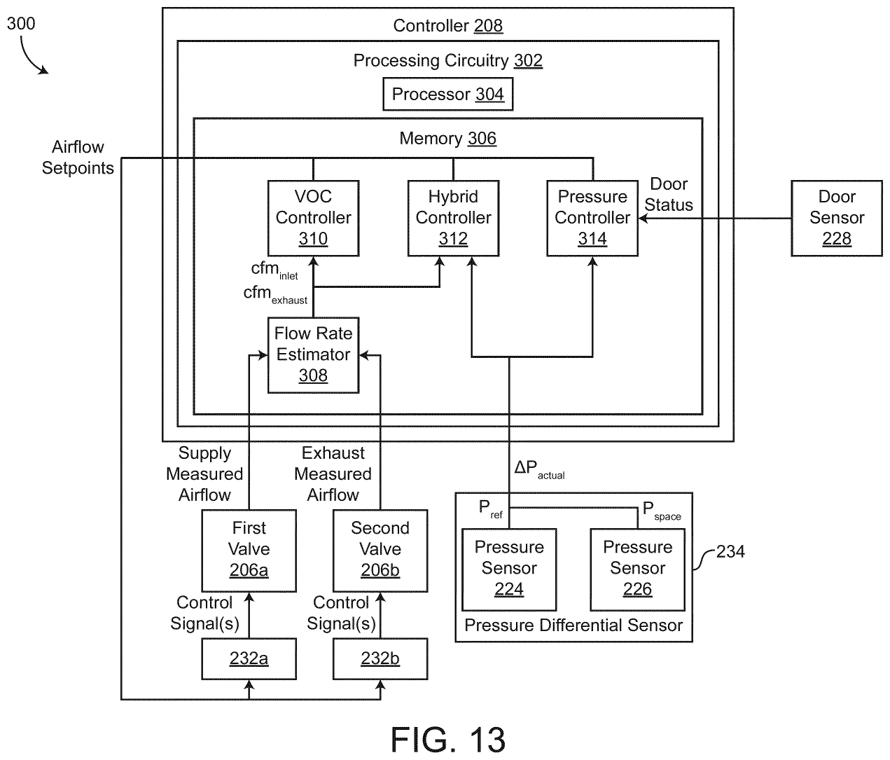

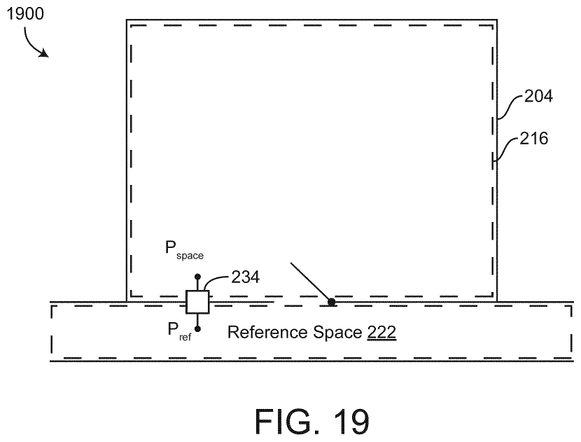

The HVAC system 200 or the control system 300 also includes a pressure sensor 226, and a pressure sensor 224. The pressure sensor 226 and the pressure sensor 224 can be provided as a single pressure differential sensor (shown as pressure differential sensor 234 in FIGS. 13 and 19) that includes both the pressure sensor 226 and the pressure sensor 224. The pressure sensor 226 is configured to monitor pressure within the space 216 p_{space} and can provide readings or measurements of the pressure within the space 216 to the controller 208. The pressure sensor 224 is configured to measure or monitor pressure within a reference space 222 p_{ref} and provide the readings or measurements of the pressure within the reference space 222 to the controller 208. In some embodiments, the HVAC system 200 includes only a single pressure differential sensor. The zone 204 may include a door and a door sensor 228 that is configured to monitor a door status. The door sensor 228 can provide the door status to the controller 208.

Each of the pressure differential sensors 207 of the valves 206 are configured to obtain or measure a pressure differential of the air that flows therethrough between two different positions. For example, the pressure differential sensor 207a of the first valve 206a can measure an inlet air pressure differential, and the pressure differential sensor 207b of the second valve 206b can measure an exhaust air or an outlet air pressure differential. The valves 206 can provide the pressure differentials to the corresponding first controller 232a and/or second controller 232b for determination of the supply measured airflow or the exhaust measured airflow thereof. The first controller 232a and the second controller 232b of the valves 206 are configured to provide the supply measured airflow and the exhaust measured airflow to the controller 208 for use in determining airflow setpoints for the first valve 206a and the second valve 206b. The airflow setpoints are provided by the controller 208 to the first controller 232a of the first valve 206a and the second controller 232b of the second valve 206b. The first controller 232a and the second controller 232b are configured to use the airflow setpoints to generate control signals for the control valve 209a and the control valve 209b of the first and second valves 206a-206b to control or adjust the supply measured airflow and the exhaust measured airflow to achieve or be driven towards the airflow setpoints. In this way, the controller 208 may determine airflow setpoints for the first valve 206a and the second valve 206b based on supply measured airflow and exhaust measured airflow, and the first controller 232a and the second controller 232b can be configured to generate control signals for the first valve 206a and the second valve 206b based on the airflow setpoints, and to determine the supply measured airflow and the exhaust measured airflow based on the pressure differentials obtained at the first valve 206a and the second valve 206b.

The controller 208 is configured to obtain any of the supply measured airflow from the first controller 232a of first valve 206a, the exhaust measured airflow from the second controller 232b of the second valve 206b, the door status from the door sensor 228, the space pressure p_{space} from the pressure sensor 226, and the reference pressure p_{ref} from the pressure sensor 224 (or a pressure differential Δp from the pressure differential sensor 234), according to some embodiments. The controller 208 can also obtain feedback or operational data from the AHU 202. The controller 208 uses the inputs described herein to generate airflow setpoints for the first valve 206a, and/or the second valve 206b according to a control scheme. In some embodiments, the airflow setpoint for the first valve 206a and the airflow setpoint for the second valve 206b are used by the controllers 232 of the valves 206 to generate control signals for the control valves 209 thereof to adjust a flowrate of air that is provided to the space 216 or to adjust a flowrate of air that leaves or exits the space 216 (e.g., to adjust the supply measured airflow and/or the exhaust measured airflow). The controller 208 can operate according to a variety of different control schemes, including a volumetric offset control (VOC) scheme, a pressure based control scheme, or a hybrid control scheme that uses techniques from both the VOC scheme and the pressure based control scheme. The controller 208 can use the supply measured airflow and the exhaust measured airflow obtained from the first valve 206a and the second valve 206b to determine a volumetric flowrate (e.g., a cfm) of the inlet air and a volumetric flowrate of the outlet air (e.g., the airflow setpoints).

Referring now to FIG. 13, the control system 300 is shown in greater detail, according to some embodiments. The control system 300 includes the controller 208 that is in communication with the first valve 206a (or sensors thereof), the second valve 206b (or sensors thereof), the pressure sensor 224, the pressure sensor 226 (and/or the pressure differential sensor 234), the AHU 202, and/or the door sensor 228. The controller 208 is shown to include processing circuitry 302 including a processor 304 and memory 306. The processor 304 may be a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Processor 304 may be a microprocessor, or, any conventional processor, controller, microcontroller, or state machine. Processor 304 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

Memory 306 (e.g., memory, memory unit, storage device) may include one or more devices (e.g., RAM, ROM, Flash memory, hard disk storage) for storing data and/or computer code for completing or facilitating the various processes, layers and modules described in the present disclosure. Memory 306 may be or include volatile memory or non-volatile memory, and may include database components, object code components, script components, or any other type of information structure for supporting the various activities and information structures described herein. According to an exemplary embodiment, the memory 306 is communicably connected to the processor 304 via the processing circuitry 302 and include computer code for executing (e.g., by the processing circuitry 302 or the processor 304) the one or more processes described herein.

Referring still to FIG. 13, the memory 306 is shown to include a VOC controller 310, a hybrid controller 312, a pressure controller 314, and a flowrate estimator 308. The flowrate estimator 308 is configured to obtain the supply measured airflow from the first valve 206a (or more specifically, from the first controller 232a) and the exhaust measured airflow from the second valve 206b (or more specifically from the second controller 232b). The flowrate estimator 308 is configured to use the supply measured airflow and the exhaust measured airflow to determine a volumetric flowrate of air that enters and leaves the space 216 (e.g., in appropriate units for the VOC controller 310 and/or the hybrid controller 312). For example, the volumetric flowrate of air that enters the space 216 may be expressed in units of cubic feet per minute cfmᵢₙₗₑₜ and the volumetric flowrate of air that leaves the space 216 may be expressed in units of cubic feet per minute cfmₑₓₕₐᵤₛₜ. The flowrate estimator 308 can estimate, calculate, determine, etc., the flowrates, and can provide the flowrates (e.g., cfmᵢₙₗₑₜ and cfmₑₓₕₐᵤₛₜ) to any of the VOC controller 310, the hybrid controller 312, and/or the pressure controller 314.

The VOC controller 310 is configured to receive the flowrates cfmᵢₙₗₑₜ and cfmₑₓₕₐᵤₛₜ and generate the airflow setpoints for the first valve 206a and/or the second valve 206b according to a VOC control scheme. The VOC controller 310 can determine a difference between the flowrates:

Δcfm_{actual}=cfmᵢₙₗₑₜ−cfmₑₓₕₐᵤₛₜ

according to some embodiments. In some embodiments, the difference Δcfm_{actual} is an actual difference between the volumetric flowrate of the inlet air and the volumetric flowrate of the exhaust or outlet air.

The VOC controller 310 also uses a volumetric offset setpoint Δcfmₛₑₜ, according to some embodiments. In some embodiments, the volumetric offset setpoint Δcfmₛₑₜ is a desired difference between inlet and outlet air of the space 216. The volumetric offset setpoint Δcfmₛₑₜ may be a positive value, indicating that the inlet air should be provided at a rate greater than the outlet air (e.g., a positive isolation mode) or may be a negative value, indicating that the inlet air should be provided at a rate less than the outlet air (e.g., a negative isolation mode).

The VOC controller 310 compares the difference Δcfm_{actual} to the volumetric offset setpoint Δcfmₛₑₜ to determine if volumetric offset setpoint Δcfmₛₑₜ has been achieved. The VOC controller 310 can examine differences between the difference Δcfm_{actual} and the volumetric offset setpoint Δcfmₛₑₜ to determine if operation of any of the first valve 206a and/or the second valve 206b should be adjusted. The VOC controller 310 can operate the first valve 206a and/or the second valve 206b to drive the difference Δcfm_{actual} toward the volumetric offset setpoint Δcfmₛₑₜ (e.g., using PID control, closed loop control, etc.). In some embodiments, the VOC controller 310 is configured to operate the first valve 206a and/or the second valve 206b to adjust the flowrate of air that is provided to the space 216 or that exits the space 216, thereby adjusting the difference Δcfm_{actual} (e.g., by adjusting the cfmᵢₙₗₑₜ and/or the cfmₑₓₕₐᵤₛₜ). For example, if the difference Δcfm_{actual} is less than the volumetric offset setpoint Δcfmₛₑₜ, the control signals generated by the VOC controller 310 can operate the second valve 206b to adjust a damper to decrease the outlet flowrate cfmₑₓₕₐᵤₛₜ, increase the inlet flowrate cfmᵢₙₗₑₜ by adjusting a damper of the first valve 206a, or both adjust the dampers of the first valve 206a and the second valve 206b to decrease the outlet flowrate cfmₑₓₕₐᵤₛₜ and increase the inlet flowrate cfmᵢₙₗₑₜ.

Advantageously, the VOC controller 310 implements a VOC control scheme to operate the first valve 206a and the second valve 206b to achieve a desired airflow offset within the space 216. The pressure can be achieved by operating the first valve 206a and the second valve 206b to provide a desired relative difference between incoming air to the space 216 and outgoing air from the space 216. In some embodiments, the first valve 206a is operated by the VOC controller 310 to achieve a desired temperature and/or indoor air quality within the space 216 and the second valve 206b is operated to adjust the outlet flowrate cfmₒᵤₜₗₑₜ to achieve the volumetric offset setpoint Δcfmₛₑₜ. In some embodiments, since the VOC controller 310 does not require pressure measurements of the space 216, the zone 204 may include stand-alone pressure sensors and displays throughout the space 216. The stand-alone pressure sensors and displays can be units that are configured to measure the pressure within the space 216 and display the pressure of the space 216 relative to a reference space or a reference pressure. This can be done to provide positive feedback to occupants of the space 216.

In some embodiments, the VOC controller 310 is used when the space 216 is a large space with air disturbance occurrences. For example, the VOC controller 310 can be used when the zone 204 includes multiple doors, multiple fume hoods, large air change rate requirements, and/or constant movement of occupants. The VOC controller 310 can also be implemented for spaces where there are multiple independent zones that are open to each other.

Referring still to FIG. 13, the memory 306 includes the pressure controller 314, according to some embodiments. In some embodiments, the pressure controller 314 is configured to receive the reference pressure p_{ref} from the pressure sensor 224, and the space pressure p_{space} from the pressure sensor 226. The pressure controller 314 can also receive a door status from one or more door sensors 228 indicating which of one or more doors are currently opened or closed.

The pressure controller 314 is configured to determine a difference between the reference pressure p_{ref} and the space pressure p_{space}, according to some embodiments. For example, the pressure controller 314 can be configured to determine an actual pressure differential:

Δp_{actual}=p_{ref}−p_{space}

or:

Δp_{actual}=p_{space}−p_{ref}

according to some embodiments. In some embodiments, the pressure differential Δp_{actual} is obtained directly from the pressure differential sensor 234.

In some embodiments, the pressure controller 314 is configured to perform closed-loop feedback using the actual pressure differential Δp_{actual} to drive the actual pressure differential Δp_{actual} toward a pressure differential setpoint Δpₛₑₜₚₒᵢₙₜ. The pressure controller 314 can generate control signals or and airflow setpoint for the second valve 206b to adjust the damper of the second valve 206b to change a flowrate of air that exits the space 216, thereby adjusting the actual pressure differential Δp_{actual}. The pressure controller 314 can generate control signals or an airflow setpoint for the first valve 206a for temperature control and/or indoor air quality control of the space 216.

The pressure controller 314 is also configured to receive the door statuses from the door sensor(s) 228 to determine if the space 216 is no longer sealed. If the pressure controller 314 detect that a door has been opened, the pressure controller 314 may delay updating or adjusting the control signals to prevent the system from going into overdrive. The pressure controller 314 may delay updating the control signals until the door status indicates that the doors are closed and that the space 216 is sealed. Once the door status indicates that the doors are closed that the space 216 is sealed, the pressure controller 314 can delay a predetermined amount of time before performing its functionality to determine adjustments to the control signals to control the second valve 206b to drive the actual pressure differential Δp_{actual} towards the pressure differential setpoint Δpₛₑₜₚₒᵢₙₜ. The door that the door sensor 228 measures the status of may fluidly couple the space 216 with the reference space 222 when opened.

Advantageously, the pressure controller 314 can be implemented when the space 216 is a substantially sealed space with minimal leakage. For example, the efficiency of the pressure controller 314 may increase when the space 216 is sealed with minimal leakage. The space 216 can be sealed to improve the efficiency of the pressure controller 314 through the use of good gap seals/skirts, ceiling tile seals, light fixture sealing, and/or window crack sealing, to facilitate minimal air use. In some embodiments, the pressure controller 314 is implemented when the space 216 is a smaller space with minimal disturbances that require a rapid and real-time response to changing conditions to maintain a desired pressure in the space 216 and a desired level of safety.

Referring still to FIG. 13, the memory 306 includes the hybrid controller 312, according to some embodiments. The hybrid controller 312 can be configured to implement techniques or functionality of both the VOC controller 310 and the pressure controller 314. For example, the hybrid controller 312 can obtain any of the supply measured airflow from the first valve 206a (or from the first controller 232a of the first valve 206a), the exhaust measured airflow from the second valve 206b (or from the second controller 232b of the second valve 206b), the reference pressure p_{ref} from the pressure sensor 224, the space pressure p_{space} from the pressure sensor 226 (or the pressure differential Δp_{actual} from the pressure differential sensor 234), and/or the door status from the door sensor 228. In some embodiments, the hybrid controller 312 is configured to perform the functionality of the VOC controller 310 as described above, while monitoring the actual pressure differential Δp_{actual} between the space 216 and the reference space 222. The hybrid controller 312 can use a pressure deadband D; that defines a range of acceptable pressure differential values. If the hybrid controller 312 detects that the actual pressure differential Δp_{actual} is outside of or approaching a boundary of the pressure deadband DBₚ, the hybrid controller 312 is configured to update the volumetric offset setpoint Δcfmₛₑₜ and operate according to the VOC controller 310 functionality described above using the updated volumetric offset setpoint Δcfmₛₑₜ to drive the actual pressure differential Δp_{actual} back into the pressure deadband DBₚ. In this way, the hybrid controller 312 can operate the first valve 206a and the second valve 206b according to the functionality of the VOC controller 310 as described in greater detail above, while using the actual pressure differential Δp_{actual} as an indicator of whether or not the volumetric offset setpoint Δcfmₛₑₜ should be updated.

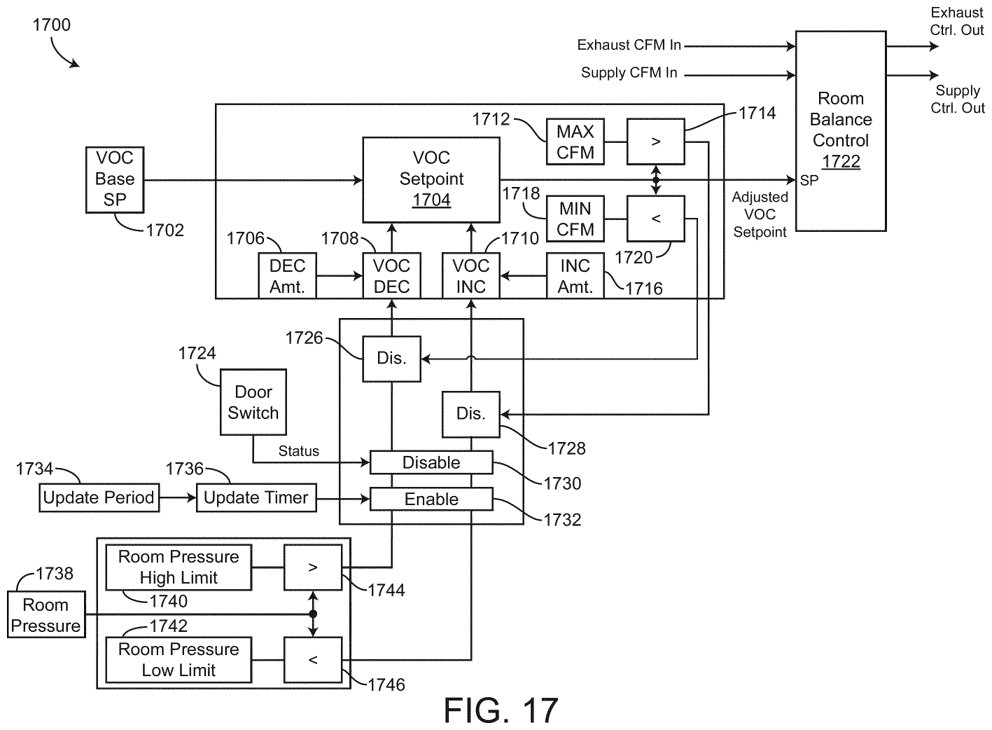

Referring now to FIG. 17, a diagram 1700 of the functionality of the hybrid controller 312 is shown, according to some embodiments. The diagram 1700 illustrates the functionality of the controller 208 when the hybrid controller 312 is implemented, as well as the inputs and outputs of the controller 208 for the implementation of the hybrid controller 312.

Room pressure 1738 can be obtained from the pressure sensor 224 and/or the pressure sensor 226. The room pressure 1738 is compared to a room pressure high limit 1740 and a room pressure low limit 1742. The room pressure high limit 1740 and the room pressure low limit 1742 can defined the pressure deadband DBₚ. If the room pressure 1738 is above the room pressure high limit 1740 or below the room pressure low limit 1742 (e.g., by comparing the room pressure 1738 to the room pressure high limit 1740 or the room pressure low limit 1742 at the comparison blocks 1744 and 1746, respectively), a setpoint adjustment process can be enabled at enable block 1732. In some embodiments, the setpoint adjustment process or functionality can be delayed to a later time based on an updated period 1734 and/or an updated timer 1736. For example, the setpoint adjustment process can be delayed to a scheduled interval as determined or provided by the updated period 1734 and/or the updated timer 1736.

In some embodiments, the setpoint adjustment process or functionality can be disabled or prevented from occurring (even if the room pressure 1738 is outside of the pressure deadband DBₚ) based on a status of a door switch 1724. The door switch 1724 can be the door sensor 228 as described in greater detail above. If the status indicates that a door that the door switch 1724 monitors is open, a disable block 1730 can disable either a setpoint increase or a setpoint decrease at disable blocks 1728 and 1726, respectively.

In some embodiments, a VOC setpoint 1704 (e.g., a setpoint that is determined or adjusted for volumetric offset control) is determined based on a VOC base setpoint 1702 (e.g., a starting value, an initial value, a predetermined value, etc.), and one or more increases 1708 or decreases 1710. If the room pressure 1738 is greater than the room pressure high limit 1740, the VOC setpoint 1704 can be decreased by reducing the VOC setpoint 1704 by a decrease amount 1706 (this action is shown at the VOC decrease block 1708), according to some embodiments. Similarly, if the room pressure 1738 is less than the room pressure low limit 1742, the VOC setpoint 1704 can be increased by increasing the VOC setpoint 1704 by an increase amount 1706 (this action is shown at the VOC increase block 1710), according to some embodiments.

The VOC setpoint 1704 can then be compared to a maximum limit 1712 and a minimum limit 1716 (shown as CFM limits). The VOC setpoint 1704 can be capped at the maximum limit 1712 and the minimum limit 1718, respectively. For example, if the VOC setpoint 1704 is greater than or equal to the maximum limit 1712 (this action is shown at a comparison block 1714), setpoint increases can be disabled (shown at the disable block 1728). Similarly, if the VOC setpoint 1704 is less than or equal to the minimum limit 1718, setpoint decreases can be disabled (shown at the disable block 1726).

The VOC setpoint 1704, including any increases or decreases can be provided to a room balance controller 1722 as an adjusted VOC setpoint. The room balance controller 1722 can be the same as or similar to the VOC controller 310 as described in greater detail above with reference to FIG. 13. The room balance controller 1722 uses the adjusted VOC setpoint, an exhaust CFM measurement, and a supply CFM measurement. The room balance controller 1722 determines control signal outputs for an exhaust valve and a supply valve (e.g., the valve 206a and the valve 206b) and provides the control signals to the exhaust valve and the supply valve, respectively, so that the exhaust valve and the supply valve operate to achieve the adjusted VOC setpoint. It should be understood that the VOC setpoint 1704 and the adjusted VOC setpoint are setpoints for a flowrate differential between air entering and leaving (e.g., exhaust and supply) a space or a room that the controller which implements the functionality of the diagram 1700 serves.

Referring now to FIG. 19, a diagram 1900 of a configuration of the pressure differential sensor 234 is shown, according to some embodiments. The pressure differential sensor 234 can be provided between the space 216 and the reference space 222. In this way, the pressure differential sensor 234 can be configured to measure both the space pressure p_{space} of the space 216 and the reference pressure p_{ref} of the reference space 222 to measure the actual pressure differential Δp_{actual} therebetween. The pressure differential sensor 234 can include the pressure sensor 224 and the pressure sensor 226, or may include probes for sampling and measuring air in both the space 216 and the reference space 222. In some embodiments, the space 216 is selectably fluidly coupled with the reference space 222 (e.g., through a door). The space 216 may be pressurized to a pressure that is greater than the reference space 222 and can be substantially sealed relative to the reference space 222 when the door is closed.

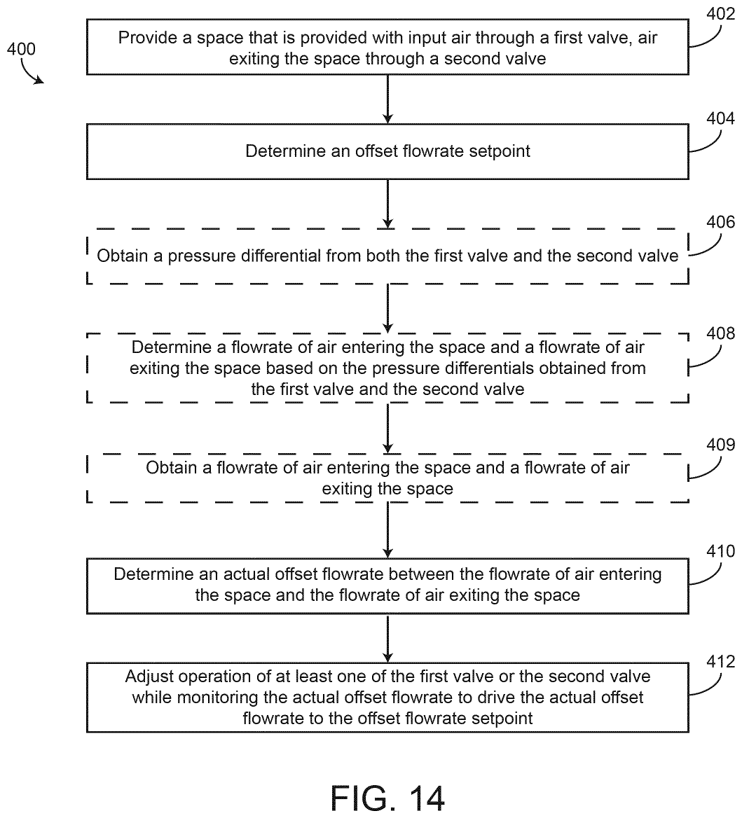

Referring now to FIG. 14, a flow diagram of a process 400 for operating an HVAC system according to a VOC control scheme is shown, according to some embodiments. The process 400 includes steps 402-412, and can be performed, at least in part, using the control system 300 or the controller 208.

Process 400 includes providing a space that is provided with input air through a first valve, where air exits the space through a second valve (step 402), according to some embodiments. The first valve may be the first valve 206a and the second valve may be the second valve 206b. The first valve operate in conjunction with an AHU to provide air into the space, while the second valve may operate to control a rate at which air leaves the space.

Process 400 includes determining an offset flowrate setpoint (step 404), according to some embodiments. In some embodiments, the offset flowrate setpoint is a desired difference between a flowrate of air that enters the space and a flowrate of air that leaves the space. For example, the offset flowrate setpoint can be the volumetric offset setpoint Δcfmₛₑₜ as described in greater detail above with reference to FIG. 13. The offset flowrate setpoint can be provided as a user input or can be stored in memory of the controller 208. Step 404 can be performed by the VOC controller 310 of the controller 208.

Process 400 includes obtaining a pressure differential from both the first valve and the second valve (step 406), according to some embodiments. The pressure differentials can be pressure differentials of different positions along the first valve and the second valve, respectively. In some embodiments, the pressure differentials are provided to the controller 208 from the first valve 206a and the second valve 206b. The pressure differential of each of the first valve 206a and the second valve 206b can be obtained using any of the techniques described in greater detail above with reference to the air duct assembly 1. Step 406 can be performed by the flowrate estimator 308 of the controller 208. In some embodiments, step 406 is performed by controllers of the first valve and the second valve. For example, step 406 can be performed by the first controller 232a of the first valve 206a and the second controller 232b of the second valve 206b.

Process 400 includes determining a flowrate of air entering the space and a flowrate of air exiting the space based on the pressure differentials obtained from the first valve and the second valve (step 408), according to some embodiments. In some embodiments, step 408 is performed by the first controller 232a and the second controller 232b. The first controller 232a and the second controller 232b can use the pressure differential obtained from the first valve and the pressure differential obtained from the second valve, and Bernoulli's equation or technique to determine the flowrates (e.g., in cfm) of air entering and leaving the space. Steps 406-408 can optionally be performed by the controller 208 (e.g., by the flow rate estimator 308) or may be performed by the first controller 232a and the second controller 232b. In some embodiments, steps 406-408 are performed by the first controller 232a and the second controller 232b and step 409 is performed by the controller 208 (or more specifically, by the flow rate estimator 308).

Process 400 includes obtaining a flowrate of air entering the space and a flowrate of air exiting the space (step 409), according to some embodiments. The flowrate of air entering the space may be the supply measured airflow, while the flowrate of air exiting the space may be the exhaust measured airflow. Step 409 can be performed by the controller 208, or more specifically, by the flow rate estimator 308. The flowrate of air entering the space and the flowrate of air exiting the space may be the flowrates determined in step 408 by the first controller 232a and the second controller 232b.

Process 400 includes determining an actual offset flowrate between the flowrate of air entering the space and the flowrate of air exiting the space (step 410), according to some embodiments. Step 410 can be performed by the VOC controller 310 of the controller 208. In some embodiments, the actual offset flowrate is a difference between the flowrate of air entering the space and the flowrate of air exiting the space (e.g., as obtained in step 409).

Process 400 includes adjusting operation of at least one of the first valve or the second valve while monitoring the actual offset flowrate to drive the actual offset flowrate to the offset flowrate setpoint (step 412), according to some embodiments. In some embodiments, step 412 is performed by the VOC controller 310. Step 412 can include performing a closed-loop control scheme to drive the actual offset flowrate towards or to be substantially equal to the offset flowrate setpoint by generating control signals for the second valve to adjust a damper of the second valve, thereby adjusting flowrate of the air exiting the space. Step 412 can be performed by the VOC controller 310, the first controller 232a, and the second controller 232b.

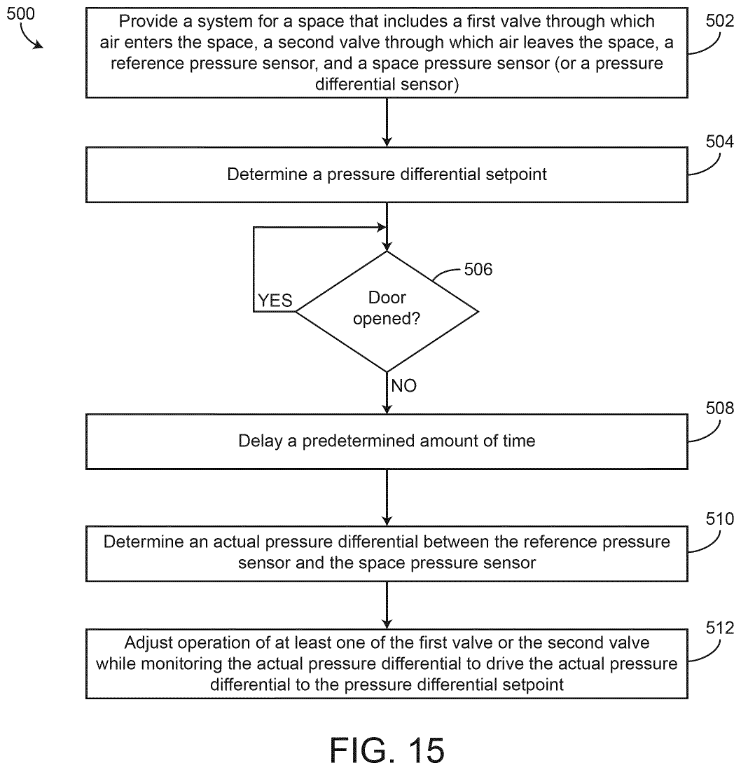

Referring now to FIG. 15, a process 500 for performing pressure based control of a space is shown, according to some embodiments. Process 500 can include steps 502-512 and can be performed by the controller 208, or more specifically, by the pressure controller 314 of the controller 208.

Process 500 includes providing a system for a space that includes a first valve through which air enters the space, a second valve through which air leaves the space, a reference pressure sensor, and a space pressure sensor (step 502), according to some embodiments. In some embodiments, the first valve is the first valve 206a, the second valve is the second valve 206b, the reference pressure sensor is the pressure sensor 224, and the space pressure sensor is the pressure sensor 226. The reference pressure sensor can be configured to read or monitor a pressure of a reference space, while the space pressure sensor is configured to read or monitor a pressure of the space that the system operates to affect. In some embodiments, the reference pressure sensor and the space pressure sensor are provided as a single pressure differential sensor that is configured to measure a pressure differential between a reference pressure and a space pressure.

Process 500 includes determining a pressure differential setpoint (step 504), according to some embodiments. In some embodiments, step 504 is performed by the pressure controller 314. In some embodiments, the pressure differential setpoint is a desired pressure differential between the space and the reference space. The pressure differential setpoint can be set by a user, an occupant (e.g., through a wall-mounted thermostat or unit), or may be a predetermined value. The pressure differential setpoint may be used by the pressure controller 314 in a closed loop pressure based control scheme.

Process 500 includes determining if a door is opened (step 506), according to some embodiments. In some embodiments, step 506 is determined based on a door status obtained by the controller 208 from a door sensor (e.g., the door sensor 228). The door may fluidly couple the space with the reference space when opened. In response to the door being detected as open (step 506, “YES”), process 500 returns to step 506 and waits for the door to close. In response to the door being detected as closed (step 506, “NO”), process 500 proceeds to step 508. Pressure differentials obtained from the pressure differential sensor can still be read and displayed, but do not need to be acted upon or used for control.

Process 500 includes delaying a predetermined amount of time (step 508) once the door is closed (step 506, “NO”), according to some embodiments. In some embodiments, delaying the predetermined amount of time prevents the system from going into overdrive. Step 508 can be performed by the pressure controller 314.

Process 500 includes determining an actual pressure differential between the reference pressure sensor and the space pressure sensor (step 510), according to some embodiments. In some embodiments, step 510 includes determining a difference between the space pressure and the reference pressure (e.g., real-time sensor data). Step 510 can be performed by the pressure controller 314 based on the sensor data obtained from the pressure sensor 224 and the pressure sensor 226.

Process 500 includes adjusting operation of at least one of the first valve or the second valve while monitoring the actual pressure differential (e.g., as obtained in step 510) to drive the actual pressure differential to the pressure differential setpoint (step 512), according to some embodiments. In some embodiments, step 512 is performed by the pressure controller 514 using a closed loop pressure based control scheme. Step 512 can include adjusting the second valve to increase or decrease a flowrate of air leaving the space to drive the actual pressure differential toward the pressure differential setpoint. Step 512 can be performed by the pressure controller 314, the first controller 232a, and the second controller 232b.

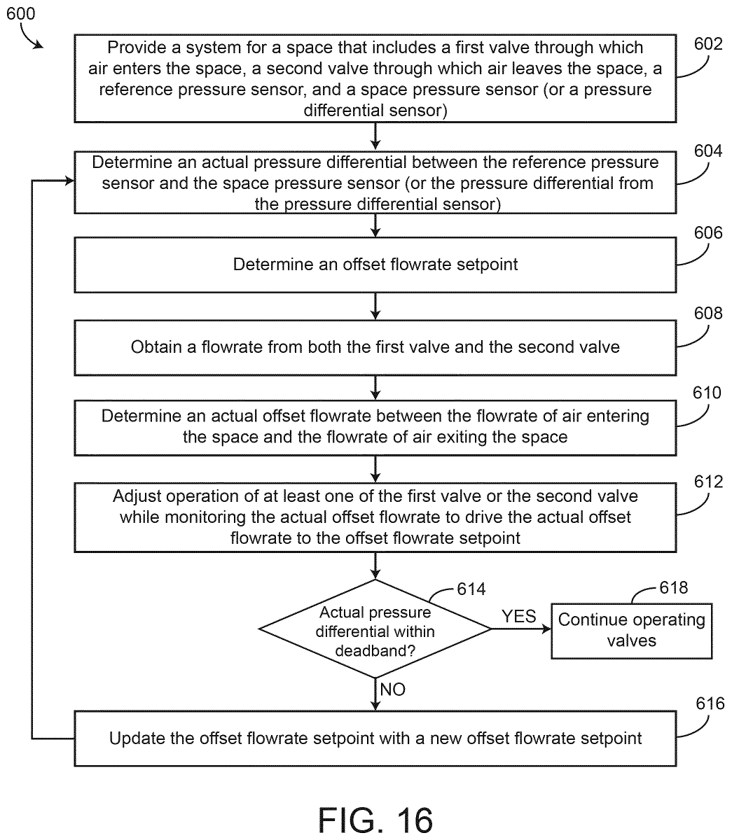

Referring now to FIG. 16, a flow diagram of a process 600 for performing a hybrid control scheme is shown, according to some embodiments. Process 600 can include steps 602-618 and may be performed by the hybrid controller 312 of the controller 208. Process 600 may integrate functionality of both the VOC controller 310 (or process 400) and the pressure controller 314 (or process 500) in a hybrid control scheme. Process 600 can be performed by the control system 300, or more particularly, by the hybrid controller 312.

Process 600 includes providing a system for a space that includes a first valve through which air enters the space, a second valve through which air leaves the space, a reference pressure sensor, and a space pressure sensor (step 602), according to some embodiments. Step 602 can be the same as or similar to step 502 of process 500. Process 600 also includes determining an actual pressure differential between the reference pressure sensor and the space pressure sensor (step 604), according to some embodiments. In some embodiments, step 604 is the same as or similar to step 510 of process 500. The reference pressure sensor and the space pressure sensor can be provided as a single pressure differential sensor (e.g., the pressure differential sensor 234).

Process 600 also includes determining an offset flowrate setpoint (step 606), obtaining a flowrate from both the first valve and the second valve (step 608), determining an actual flowrate between the flowrate of air entering the space and the flowrate of air exiting the space (step 610), and adjusting operation of at least one of the first valve or the second valve while monitoring the actual offset flowrate to drive the actual offset flowrate to the offset flowrate setpoint (step 612), according to some embodiments. In some embodiments, steps 606-614 are the same as or similar to steps 404-412 of process 400.

Process 600 includes determining if the actual pressure differential is within a pressure deadband (step 614), according to some embodiments. Step 614 can be performed in real-time or concurrently with any of steps 606-612. In some embodiments, the actual pressure differential is the pressure differential between the space pressure and the reference pressure as determined in step 604. If the actual pressure differential is within the deadband (step 614, “YES”), process 600 proceeds to step 616 and continues operating the valves. If the actual pressure differential is not within the deadband (step 614, “NO”), process 600 proceeds to step 616.

Process 600 includes updating the offset flowrate with a new offset flowrate setpoint (step 616) in response to the actual pressure differential not being within the deadband (step 614, “NO”), according to some embodiments. In some embodiments, step 616 is performed by the pressure controller 314. In some embodiments, after performing step 616, process 600 returns to step 602 and performs steps 602-612 using the new offset flowrate setpoint.

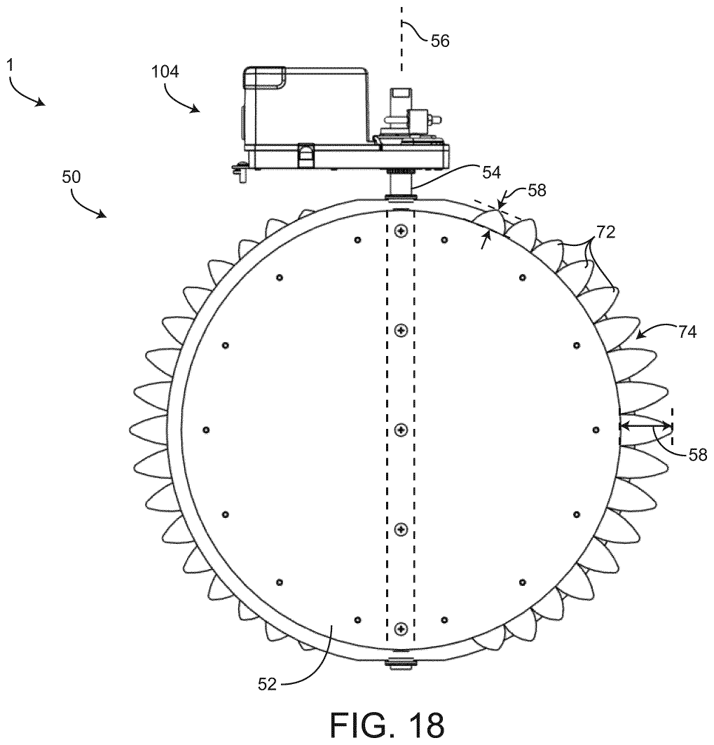

Referring now to FIG. 18, a portion of the air duct assembly 1 is shown in greater detail, according to some embodiments. Specifically, FIG. 18 shows the damper assembly 50 in greater detail. The damper assembly 50 can be driven by the actuator 104 to rotate about an axis 56 defined by a shaft 54 of the damper assembly 50. The damper assembly 50 includes a structural member 52 (e.g., a disk) that is fixedly coupled (e.g., fastened) with the shaft 54. The damper assembly 50 also includes multiple fingers, radially extending members, rubber members, sealing members, etc., shown as fingers 72. The fingers 72 are fixedly coupled at an outer edge of the structural member 52 along both a leading edge and a trailing edge of the structural member 52. The fingers 72 can have a generally arcuate or curved shape and each protrude a varying distance 58 from the outer edge of the structural member 52. The distance 58 of the fingers 72 may increase and then decrease along the outer edge of the structural member 52, with a finger 72 that is orthogonal or perpendicular with the axis 56 having a greatest distance 58. Adjacent fingers 72 may define a space 74 therebetween.

When the damper assembly 50 is driven to rotate about the axis 56, the fingers 72 on the leading edge may be driven into contact with the interior wall 4 at a leading position of the interior wall 4, and the fingers 72 on the leading edge may be driven into contact with the interior wall 4 at a trailing position of the interior wall 4. The damper assembly 50 can be driven to rotate about the axis 56 until the fingers 72 on the leading edge and the trailing edge of the structural member 52 fully engage the interior wall 4 (e.g., thereby limiting or preventing airflow through the air duct assembly 1 and substantially “shutting” the air duct assembly 1). The damper assembly 50 can also be driven to rotate about the axis 56 to an intermediate position so that the fingers 72 only partially engage the interior wall 4 of the air duct assembly 1. When the damper assembly 50 is driven to the intermediate position so that the fingers 72 only partially engage the interior wall 4, the spaces 74 therebetween the fingers 72 can allow air to flow between the fingers 72. Rotation of the damper assembly 50 incremental amounts can cause the spaces 74 between the fingers 72 to increase or decrease, thereby adjusting a cross-sectional area through which the air flows. In this way, rotation of the damper assembly 50 can result in changes of flowrate through the air duct assembly 1.

As used in the specification and the appended claims, the singular forms “a,” “an” and “the” include plural referents unless the context clearly dictates otherwise.

“Optional’ or “optionally” means that the subsequently described event or circumstance may or may not occur, and that the description includes instances where said event or circumstance occurs and instances where it does not.

Throughout the description and claims of this specification, the word “comprise” and variations of the word, such as “comprising’ and “comprises,” means “including but not limited to,” and is not intended to exclude, for example, other additives, components, integers or steps. “Exemplar” means “an example of” and is not intended to convey an indication of a preferred or ideal embodiment. “Such as” is not used in a restrictive sense, bur for explanatory purposes.

Disclosed are components that can be used to perform the disclosed methods, equipment and systems. These and other components are disclosed herein, and it is understood that when combinations, subsets, interactions, groups, etc., of these components are disclosed that while specific reference of each various individual and collective combination and permutation of these may not be explicitly disclosed, each is specifically contemplated and described herein, for all methods, equipment and systems. This applies to all aspects of this application including, but not limited to, steps in disclosed methods. Thus, if there ae a variety of additional steps that can be performed it is understood that each of these additional steps can be performed with any specific embodiment or combination of embodiments of the disclosed methods.

It should further be noted that any patents, applications and publications referred to herein are incorporated by reference in their entirety.

What is claimed is:

1. A heating, ventilation, or air conditioning (HVAC) system for a space, the HVAC system comprising:
a valve configured to control an exhaust flowrate of exhaust air that exits the space or a supply flowrate of inlet air that enters the space, wherein the valve is configured to provide sensor data indicating a flowrate therethrough;
a pressure differential sensor configured to measure an actual pressure differential of the space relative to a reference pressure; and
a controller configured to:
determine an actual offset flowrate between the supply flowrate and the exhaust flowrate;
operate the valve to adjust the exhaust flowrate or the supply flowrate to drive the actual offset flowrate toward an offset flowrate setpoint;
obtain the actual pressure differential from the pressure differential sensor; and
update the offset flowrate setpoint in response to the actual pressure differential being greater than a maximum allowable pressure differential or less than a minimum allowable pressure differential.

2. The HVAC system of claim 1, wherein:
the valve is a first valve configured to measure an inlet pressure differential between two stream locations along the first valve and control the supply flowrate of inlet air that enters the space, the inlet pressure differential indicating the supply flowrate through the first valve; and
the HVAC system further comprises a second valve configured to measure an outlet pressure differential between two stream locations along the second valve and control the exhaust flowrate of air that exits the space, the outlet pressure differential indicating the exhaust flowrate through the second valve.

3. The HVAC system of claim 1, wherein the controller is configured to:
obtain a value of the supply flowrate, a value of the exhaust flowrate, and a value of the actual pressure differential of the space;
obtain the offset flowrate setpoint and a pressure deadband; and
operate the valve to control the supply flowrate of inlet air that enters the space or the exhaust flowrate of exhaust air that exits the space based on the value of the supply flowrate, the value of the exhaust flowrate, the value of the actual pressure differential of the space, the offset flowrate setpoint, and the pressure deadband.

4. The HVAC system of claim 1, wherein updating the offset flowrate setpoint comprises:
decreasing the offset flowrate setpoint by a decrease amount in response to the actual pressure differential being greater than the maximum allowable pressure differential; and
increasing the offset flowrate setpoint by an increase amount in response to the actual pressure differential being less than the minimum allowable pressure differential.

5. The HVAC system of claim 1, wherein the controller is configured to:
operate the valve to adjust the exhaust flowrate of the exhaust air or the supply flowrate of inlet air to drive the actual offset flowrate towards the updated offset flowrate setpoint.

6. The HVAC system of claim 1, wherein the controller is configured to:
detect a pressure override condition based on the actual pressure differential of the space;
detect whether a door of the space is open;
in response to detecting that the door of the space is not open:
update the offset flowrate setpoint in response to the pressure override condition; and
in response to detecting that the door of the space is open:
delaying update of the offset flowrate setpoint until the door of the space is not open.

7. The system of claim 6, wherein the controller is configured to:
operate the valve to adjust the exhaust flowrate of the exhaust air or the supply flowrate of the inlet air to drive an actual offset flowrate towards the updated offset flowrate setpoint.

8. The HVAC system of claim 1, wherein the valve comprises:
a sidewall defining an inner surface;
an air damper assembly comprising a plurality of fingers, the plurality of fingers positioned along a circumference of a structural member of the air damper assembly and comprising different lengths along the circumference of the structural member; and
an actuator configured to drive the air damper assembly to rotate, wherein the plurality of fingers are configured to contact the inner surface of the sidewall to adjust a cross-sectional flow area and thereby adjust flowrate of air through the valve.

9. A controller for an HVAC system, the controller comprising processing circuitry configured to:
perform a volumetric offset control (VOC) scheme based on a flowrate offset setpoint to operate a valve to drive an actual flowrate offset between a supply rate of air entering a space and an exhaust rate of air leaving the space toward the flowrate offset setpoint, wherein the valve is configured to control the supply rate of air entering the space or the exhaust rate of air leaving the space and to provide sensor data indicating a flowrate therethrough;
monitor a pressure of the space to detect a pressure condition;
update the flowrate offset setpoint in response to detecting the pressure condition; and
perform the VOC scheme based on the updated offset flowrate setpoint.

10. The controller of claim 9, wherein the valve is an exhaust valve configured to control the exhaust rate of air leaving the space and performing the VOC scheme comprises:
operating the exhaust valve of the space to adjust the exhaust rate of air leaving the space to drive the actual flowrate offset toward the flowrate offset setpoint; and
operating a supply valve of the space to adjust the supply rate of air entering the space to achieve a desired environmental condition of the space.

11. The controller of claim 9, wherein monitoring the pressure of the space to detect the pressure condition comprises:
obtaining the pressure of the space;
comparing the pressure of the space to a high pressure limit and a low pressure limit; and
detecting the pressure condition in response to the pressure of the space being greater than the high pressure limit or less than the low pressure limit.

12. The controller of claim 11, wherein updating the flowrate offset setpoint comprises:
increasing the flowrate offset setpoint by a predetermined increase amount in response to the pressure of the space being greater than the high pressure limit; and
decreasing the flowrate offset setpoint by a predetermined decrease amount in response to the pressure of the space being less than the low pressure limit.

13. The controller of claim 12, wherein the processing circuitry is configured to:
limit subsequent increases of the flowrate offset setpoint in response to the flowrate offset setpoint being equal to a maximum limit; and
limit subsequent decreases of the flowrate offset setpoint in response to the flowrate offset setpoint being equal to a minimum limit.

14. The controller of claim 9, wherein the processing circuitry is further configured to:
obtain a status from a door sensor, the status indicating whether a door of the space is opened or closed;
in response to the status indicating that the door of the space is opened, preventing updates to the flowrate offset setpoint until the door of the space is closed; and
in response to the status of the door transitioning from opened to closed, preventing updates to the flowrate offset setpoint until a delay time period has passed.

15. A method for controlling an HVAC system of a space, the method comprising:
operating a valve of the space according to a volumetric offset control (VOC) scheme to drive an actual offset flowrate between a supply rate of air entering the space and an exhaust rate of air leaving the space toward a VOC setpoint, wherein the valve is configured to control the supply rate of air entering the space or the exhaust rate of air leaving the space and to provide sensor data indicating a flowrate therethrough;
detecting a pressure condition of the space; and
in response to detecting the pressure condition of the space:
updating the VOC setpoint to determine an adjusted VOC setpoint; and
operating the valve of the space according to the VOC scheme based on the adjusted VOC setpoint.

16. The method of claim 15, wherein the pressure condition comprises at least one of:
a pressure of the space exceeding a high pressure limit; or
the pressure of the space being less than a low pressure limit.

17. The method of claim 16, wherein updating the VOC setpoint comprises:
increasing the VOC setpoint by an increase amount in response to the pressure of the space being less than the low pressure limit; or
decreasing the VOC setpoint by a decrease amount in response to the pressure of the space being greater than the high pressure limit.

18. The method of claim 15, wherein the VOC setpoint is a setpoint offset amount between the supply rate of air entering the space and the exhaust rate of air leaving the space.

19. The method of claim 15, further comprising:
limiting updates to the VOC setpoint in response to a door of the space being opened until the door is closed for a predetermined amount of time; and
delaying updates to the VOC setpoint for the predetermined amount of time in response to the door of the space transitioning from opened to closed.

20. The method of claim 15, wherein the valve comprises:
a sidewall defining an inner surface;
an air damper assembly comprising a plurality of fingers, the plurality of fingers positioned along a circumference of a structural member of the air damper assembly and comprising different lengths along the circumference of the structural member; and
an actuator configured to drive the air damper assembly to rotate, wherein the plurality of fingers are configured to contact the inner surface of the sidewall to adjust a cross-sectional flow area and thereby adjust a flowrate of air through the valve.
